(19) United States
(12) Patent Application Publication
(10) Pub. No.: US 2026/0075681 A1
(43) Pub. Date: Mar. 12, 2026

(54) HEATING ELEMENT, HEATING SYSTEM AND MANUFACTURING METHOD

(71) Applicant: Dyson Technology Limited, Malmesbury, Wiltshire (GB)

(72) Inventors: Robert STREETER, Swindon (GB); James Evon DSOUZA, Singapore (SG); Mahesh SURENDRAN, Singapore (SG)

(21) Appl. No.: 19/105,888

(22) PCT Filed: Aug. 22, 2023
(86) PCT No.: PCT/IB2023/058347

§ 371 Date: Feb. 24, 2025

(30) Foreign Application Priority Data
Aug. 24, 2022 (GB) 2212321.0

(51) Int. Cl. H05B 3/16; G06K 7/10; G06K 7/14; H05B 1/02

(52) U.S. Cl. CPC H05B 3/16; G06K 7/10366; G06K 7/1417; H05B 1/02; H05B 2203/003; H05B 2203/005; H05B 2203/017

(57) ABSTRACT

A heating element with a self-balancing effect can be included in an appliance. The heating element includes a substrate and a plurality of resistive heating traces for connection to a power source. Each trace includes a first electrical contact and a second electrical contact. Each trace further includes an input portion connected to the first electrical contact, an output portion connected to the second electrical contact, and a zone-defining portion connected at a first end to the input portion and at a second end to the output portion. he zone-defining portion of the trace defining a respective zone having at least three laterally adjacent trace portions of that trace. The heating element can be included in a heating system.

### TECHNICAL FIELD OF THE INVENTION

The present invention relates to a heating element for use in an appliance, a heating system comprising the heating element, and a method of manufacturing the heating element.

### BACKGROUND TO THE INVENTION

The survival of ceramic heating elements with embedded joule heating tracks is strongly dependent on the peak temperature and evenness of temperatures spatially over the ceramic. Using even state-of-the-art manufacturing processes and equipment for co-fired ceramic heaters, an undesirably high deviation from nominal operation is observed.

FIG. 1 shows an arrangement of traces of a prior art heating element 1. The heating element 1 is arcuate, and accordingly a radial and a circumferential direction may be defined. For completeness, the circumferential direction is the direction along the curve of the arc, and the radial direction is perpendicular to this, running from the inner edge to the outer edge of the arc (or vice versa).

The heating element 1 includes three traces T1, T2, T3, which are arranged in a serpentine fashion, and mounted on e.g. a ceramic substrate (not shown). The traces define three labelled zones. Each zone comprises at least two circumferentially extending portions of track from each of the three traces T1, T2, T3, and shorter radial portions of track connecting the circumferentially extending portions.

In the heating element 1, the majority of the circumferentially extending portions are radially adjacent to a circumferentially extending portion from a different one of the three traces T1, T2, T3. As a result, increased heating in e.g. trace T1, leads to increased heating in trace T2 and T3. It has been observed that this leads to a runaway heating effect, particularly in locations downstream of the ends of the traces. FIGS. 3A and 3B illustrate this, showing high temperatures marked “H” downstream of the inputs and outputs of the traces, which are at the bottom right of the drawings. This downstream heating can cause heat sink degradation, and ultimate failure of the ceramic substrate via cracking.

The present invention has been devised in order to avoid this runaway downstream heating of the traces and, therefore, the ceramic substrate.

### SUMMARY OF THE INVENTION

Broadly speaking, the present invention addresses this by providing a heating element having a zoned layout, in which the traces are arranged into zones, each zone comprising substantially only portions of that trace. More specifically, a first aspect of the present invention provides a heating element for an appliance, the heating element comprising: a substrate; a plurality of resistive heating traces, each trace comprising a first electrical contact and a second electrical contact, each for connection to a power source; wherein: each trace comprises: an input portion connected to the first electrical contact; an output portion connected to the second electrical contact; and a zone-defining portion connected at a first end to the input portion and at a second end to the output portion, the zone-defining portion of the trace defining a respective zone and comprising at least three laterally adjacent trace portions of that trace.

Effectively, this gives rise to a set of zones, each zone containing a wound up “bunch” of trace portions, all from the same trace, rather than regions in which trace portions are highly intertwined with trace portions from other traces, which has been observed to give rise to the runaway heating effect.

In the context of the present application, a “substrate” should be understood to a component on or in which another component is located. Preferably, the plurality of resistive heating traces are located on or in the substrate. Herein, “in” the substrate may indicate that the traces are embedded within the substrate. The substrate may comprise, or be formed of, a ceramic material, due to their high temperature resistance and electrical insulation properties. Examples of ceramic materials which may be used in implementations of the present invention include aluminium oxide and aluminium nitride. Other suitable ceramic materials may also be used, such as silicon nitride, silicon oxide, zinc oxide, barium nitride.

In the context of the present application, the term “resistive heating trace” is used to refer to a conductive element which may, for example, be in the form of a wire or a thin conductive trace on a surface, which is configured to heat up in response to an applied current. The traces are preferably elongate, having a narrower width than length. In such cases, a longitudinal direction of the trace is a lengthwise direction which follows the path of the trace, and a transverse direction is perpendicular to the longitudinal direction. More simply put, a longitudinal direction is a direction along the trace, and a transverse direction is a direction across the trace. Preferably, the resistive heating traces are formed of an ohmic conductor, such as a metal. Examples of suitable metals include tungsten, tantalum, molybdenum or any combination thereof. The term “trace portion” refers to a longitudinal portion of the trace, i.e. a section along the length of the trace (as opposed to e.g. a division along the width of the trace). Herein, “laterally adjacent trace portions” are trace portions which are next to each other in the transverse direction, i.e. are located side-by-side. “Laterally adjacent” trace portions are also preferably transversely spaced. The plurality of resistive heating traces may be non-overlapping. By this, we mean that no resistive trace crosses or otherwise contacts another resistive trace. Furthermore, preferably none of the resistive traces crosses itself either, as this may give rise to an alternative current path, which could lead to non-uniform heating of the trace, and therefore the substrate. In some cases, either only the zone-defining portions of the traces may be non-overlapping, or at least the zone-defining portions of the traces may be non-overlapping. In preferred cases, however, the whole of the resistive traces are non-overlapping.

The first aspect of the invention requires that the zone-defining portion of the trace defines a respective zone. Herein, this should be understood to mean that at least part of the zone-defining portion of the trace defines the respective zone. It is not necessarily the entirety of the trace which defines the respective zone. “Zone-defining portion” may refer to the whole subsection of the trace which includes at least three laterally adjacent trace portions. Or, the whole of the zone-defining portion may comprise at least three laterally adjacent trace portions of that trace.

By increasing the extent to which portions of a given trace are laterally adjacent to portions of the same trace (e.g. relative to the arrangement shown in FIG. 1, in which no zone comprises three laterally adjacent trace portions, as required by the first aspect of the invention), the resistive traces in those zones respond to the higher temperature by having a higher electrical resistance, which in turn results in a lower power draw. This gives rise to a self-balancing effect, thus balancing out sources of part-to-part variation by having varying power draw in each of the resistive heating traces.

It is specified that each trace comprises a first electrical contact and a second electrical contract, each for connection with a power source. The first and/or second electrical contact may comprise, for example, a contact pad or a bond pad, which may be connected to an electrical power source such as a battery of the appliance, or configured to receive power from a mains supply. The input and output portions of the resistive traces are connected to the first and second electrical contacts respectively. The terms “input” and “output” in the present context are used as labels, and do not necessarily reflect the current direction or the direction of electron travel through the resistive trace. Effectively, the input and output portion of the traces are routes, respectively, to and from the zone-defining portion of the resistive traces.

We now discuss the geometry of the traces in more detail. In preferred cases, the plurality of resistive traces are serpentine traces. In the context of the present invention, “serpentine” may be understood to mean that each trace includes at least one S-shaped, or sigmoid portion. For example, when travelling longitudinally along the trace, there may be a clockwise turn followed by an anticlockwise turn, or vice versa. In a serpentine region, the respective longitudinal directions of two laterally adjacent trace portions may be opposite (in a frame of reference outside the heating element, rather than the frame of reference within the trace). In other words, when traversing that serpentine region, the direction in which one would travel along a first trace portion is opposite to the direction in which one would travel along a second, laterally adjacent, trace portion. It should be noted that one would still be travelling in the same “longitudinal” direction, which is used to refer to the direction along the trace. In a frame of reference outside the frame, the longitudinal direction may therefore vary.

In some cases, laterally adjacent trace portions within the zone-defining region are parallel to each other. Herein, the term “parallel” is used to mean “parallel or substantially parallel”. In the context of the present application, “substantially parallel” may mean that straight portions of two traces differ by no more than e.g. 5°, 10°, or 20°, or to within manufacturing tolerances.

We now discuss the geometric property of the zone-defining regions of the heating element. The following disclosure may apply to one, some, or preferably all of the resistive traces of the heating element. The zone-defining portion of each trace of the plurality of resistive heating traces may comprise a boundary region and a central region. The central region may be surrounded by the boundary region. Trace portions of the central region may be laterally adjacent (as defined previously) only the boundary region, the input portion or the output portion of that trace. In other words, trace portions of the central region are not laterally adjacent to any trace portions from a different resistive trace. Herein, “surrounded” may be understood to mean that at least 25%, 33%, 50%, 67% or 75% of the perimeter of the central region is laterally adjacent to the boundary region. In each trace, only the input portion, the output portion, and the boundary region of the zone-defining region may be laterally adjacent to a different trace of the plurality of resistive heating traces. This does not necessarily mean that all three of the input portion, the output portion, and the boundary region of the zone-defining portion must be laterally adjacent to a different trace of the plurality of resistive traces, but that only one of these portions, as opposed to e.g. the central region of the zone-defining portion may be laterally adjacent to a different trace. It will be appreciated that the central region of the zone-defining portion of each trace is isolated from other traces, which avoids runaway heating in this zone. Furthermore, because in at least the central region of each zone, the resistive traces are laterally adjacent only to other portions of the same trace, the self-balancing effect is enhanced.

Clearly, the greater the extent to which a given trace is wound up into a zone, the greater the extent to which portions of that trace will be isolated from other traces, and the greater the self-balancing effect. Accordingly, it is advantageous for the zone-defining portion to represent a significant length of each trace. More specifically, in each trace, the zone-defining portion may make up at least a first predetermined proportion of the length of the trace. The first predetermined proportion may be 25%, 30%, 33%, 35%, 40%, 45%, 50%, 55%, 60%, 67%, 70%, 75%, 80%, 85%, 90%, or 95%. Herein, when we refer to the length of the trace, we mean the total longitudinal length, the longitudinal direction having been defined already in this application. Similarly, the central region may make up at least a second predetermined proportion of the length of the zone-defining portion. The second predetermined proportion may be 25%, 30%, 33%, 35%, 40%, 45%, 50%, 55%, 60%, 67%, 70%, 75%, 80%, 85%, 90%, or 95%.

The plurality of traces may comprise a first trace and a second trace. The zone-defining portion of the first trace may define a first zone, and the zone-defining portion of the second trace may define a second zone. The plurality of traces may further comprise a third trace, the zone-defining portion of the third trace defining a third zone. The heating element may be arcuate, and accordingly some or all of the zones of the plurality of zones may also be arcuate. The heating element may have a circumferential extent of no less than 30°, 35°, 40°, 45°, 50°, or 55°, and no more than 90°, 85°, 80°, 75°, 70°, or 65°. The circumferential extent of the heating element is preferably approximately 60°.

The boundary (i.e. edge) between the first zone and the second zone may be radial, or alternatively, circumferential. The boundary between the first zone and the second zone may comprise radial and circumferential portions. The third zone may be arcuate. The boundary between the first zone and the third zone may be radial, and the boundary between the second zone and the third zone may be radial. Arrangements in which the boundary between the first zone and the second zone is circumferential, the boundary between the first zone and the third zone is radial, and the boundary between the second zone and the third zone is radial have been found to display particularly effective self-balancing.

The heating element may further comprise machine-readable indicia defining a respective duty cycle to be applied to each of the plurality of traces by a power supply. The purpose of this feature will be outlined later in this application.

The first aspect of the invention relates to a heating element, and appliance. This heating element may form part of a heating system, which is the second aspect of the invention. More specifically, a second aspect of the invention provides a heating system for an appliance, the heating system comprising: the heating element of the first aspect of the invention; and an electrical power supply configured to apply electrical current to the first contact of each of the plurality of resistive heating traces. The heating system may further comprise a controller configured to control a respective duty cycle applied to each of the first contacts of the plurality of resistive heating traces of the heating element. This variation in duty cycle is also helpful when avoiding runaway heating in certain parts of the heating element. Each trace may have a desirable, or predetermined (see later) target power draw in order to minimize undesirable heating, i.e. to minimize the peak substrate temperature, for example. Using a constant duty cycle for each trace, it has been observed that the power draw may deviate from the predetermined target values. This is thought to be an effect of manufacturing tolerances causing the manufactured part to deviate from the nominal design. It is therefore useful to vary the duty cycle from trace to trace. Of course, given the innate variability in the deviation from the nominal properties, heating elements which are installed in different heating systems may require different duty cycles from each other. In view of that, the heating system may further comprise a scanner configured to scan machine-readable indicia in order to generate duty cycle data, and to transmit the duty cycle data to the controller. Then, the controller may be configured to control the respective duty cycle applied to each of the first contacts of the plurality of resistive heating traces based on the received duty cycle data.

The “machine-readable indicia” referred to in this application may refer to e.g. visible indicia (such as an alphanumeric code, a bar code, or a QR code) which are printed or otherwise applied to a surface of e.g. the substrate of the heating element. Alternatively, the indicia may be stored in a memory of an RFID other chip, and may be obtained using an appropriate reader (which is covered by the term “scanner” in this context). The term should be interpreted broadly to cover any information which can be stored on or in the heating element and which can be read by an appropriate, preferably electronic, instrument (i.e. the scanner).

A third aspect of the present invention provides a method of manufacturing a specific implementation of the heating element of the first aspect of the invention, the method comprising the steps of: providing the substrate; applying the plurality of resistive heating traces to a surface of the substrate; measuring the operational power draw of each of the plurality of resistive heating traces (for example using an electrical power meter); and calculating a respective duty cycle to be applied to each of the plurality resistive heating traces based on the measured operational power draw; encoding the calculated duty cycles in machine-readable indicia and applying the machine-readable indicia to the heating element. In an optional additional step, the method may further comprise, after applying the plurality of resistive traces to the surface of the substrate, applying additional substrate material over the resistive heating traces, thereby causing the resistive heating traces to be embedded in the substrate material. Measuring the operational power draw and selecting an appropriate duty cycle means that the power imbalance can further be addressed, by obtaining real power measurements. It is able to take into account the power imbalance as a result of room temperature resistance, and also the imbalance due to variations in temperature across the device. In some cases, the electrical resistance may also be measured. Additional features of the manufacturing process may be as set out in US7799267B, the entirety of which is incorporated by reference herein. The invention includes the combination of the aspects and preferred features described except where such a combination is clearly impermissible or expressly avoided.

### BRIEF DESCRIPTION OF THE DRAWINGS

Embodiments of the present invention will now be described with reference to the accompanying drawings, in which:

FIG. 1 shows a prior art heating element.

FIGS. 2A to 2G show examples of heating elements according to the present invention.

FIGS. 3A and 3B show heat maps which are obtained using the prior art heating element shown in FIG. 1.

FIGS. 4A to 4H show heat maps which are obtained using the heating elements of the present invention, depicted in FIGS. 2A to 2G.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

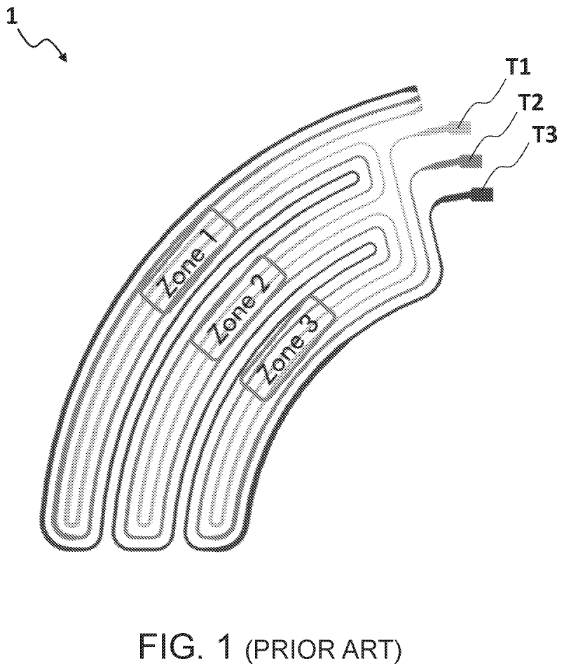

FIG. 1 shows a prior art heating element 1, and has already been described in the Background section of this patent application.

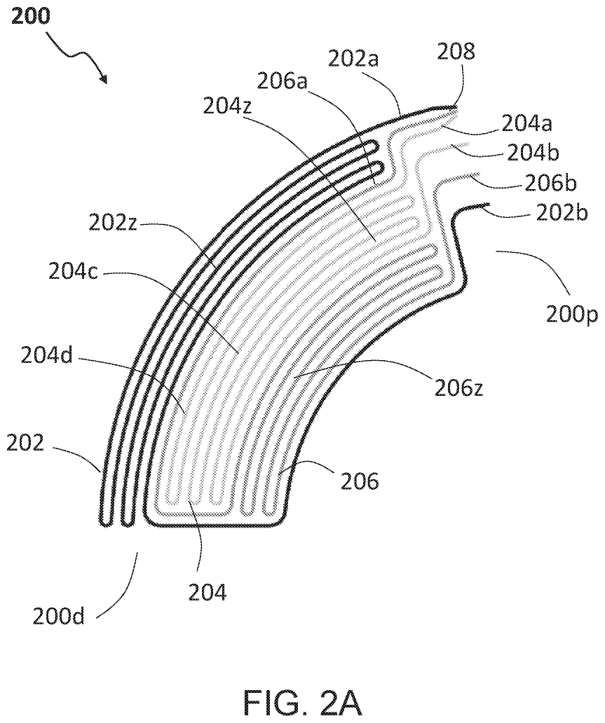

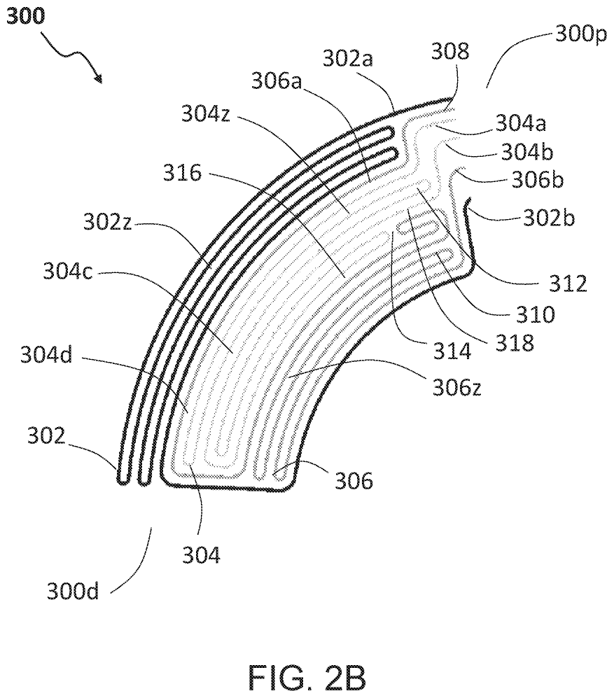

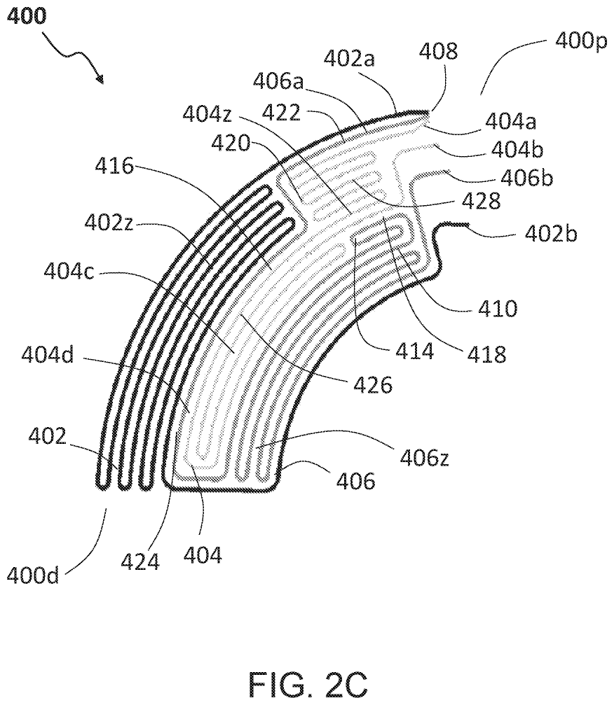

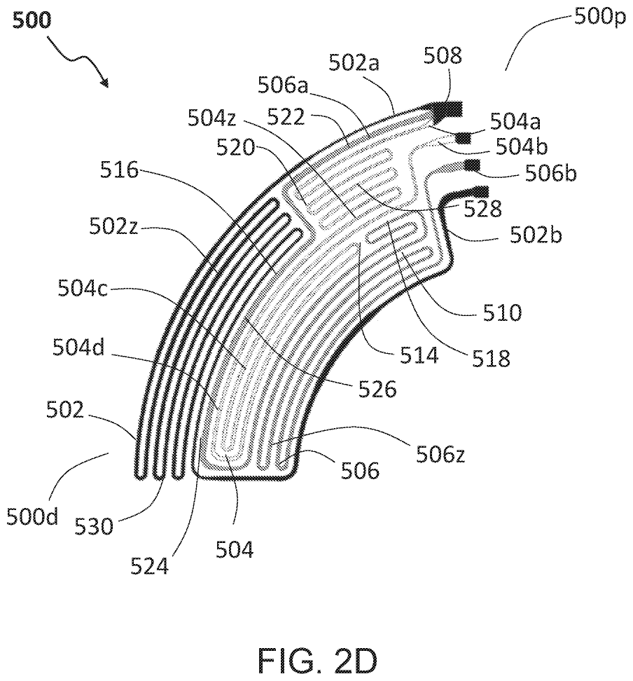

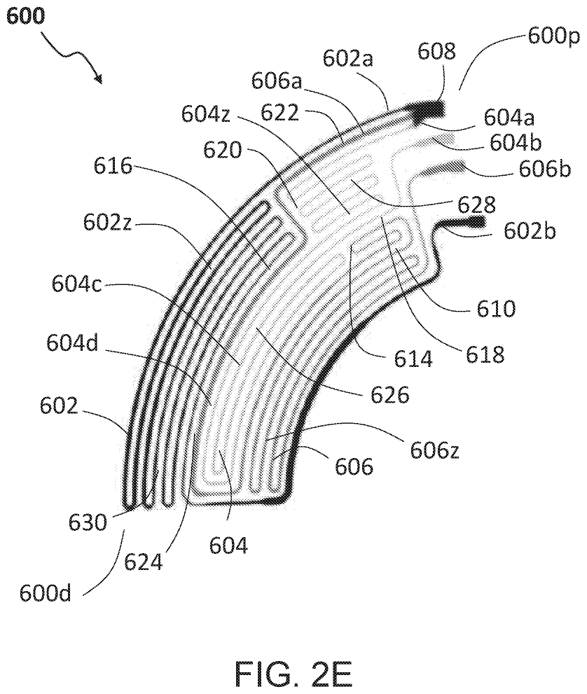

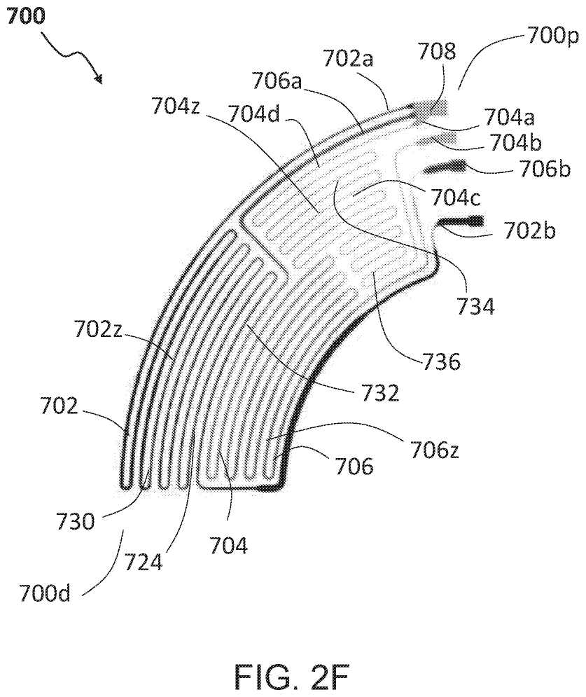

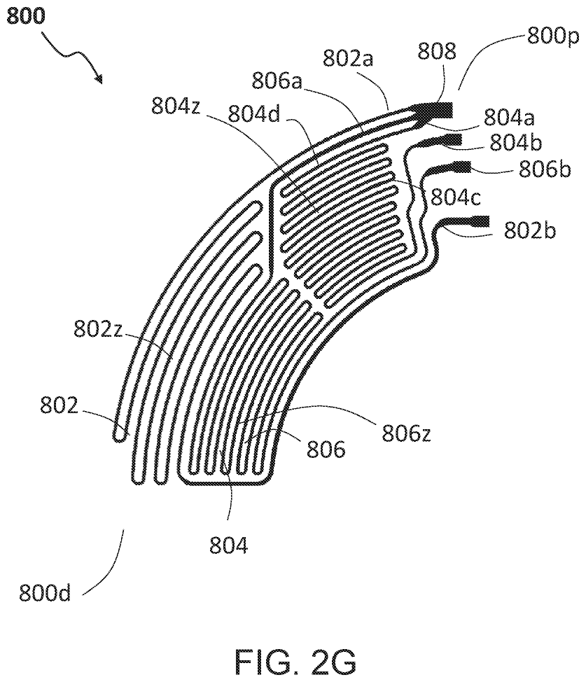

FIGS. 2A to 2G each show implementations of heating elements according to the first aspect of the present invention, and are described in detail below. The plurality of traces shown in FIGS. 2A to 2G were developed iteratively. So, for conciseness, we will describe FIG. 2A in detail and then explain the differences in FIG. 2B relative to FIG. 2A, and so on.

FIG. 2A shows a heating element 200 comprising three resistive heating traces 202, 204, 206. The heating element 200 is generally arcuate, and each of the resistive heating traces 202, 204, 206 are also generally arcuate, arranged in a “rainbow-like” configuration. The traces 202, 204, 206 are generally serpentine, and are arranged in a plurality of parallel lines extending back and forth in a circumferential direction.

The heating element 200 comprises a power input region 208 at which point traces 202, 204, 206 are all located close to each other, such that they may receive a power input from a power source. The end of the heating element 200 close to the power input region 208 may be referred to as a proximal end 200p, and the opposite end maybe referred to as a distal end 200d. Each heating trace 202, 204, 206 comprises an input region 202a, 204a, 206a, and an output region 202b, 204b, 206b. Between the input region 202a, 204a, 206a, and the output region 202b, 204b, 206b of each trace 202, 204, 206 is a zone-defining portion 202z, 204z, 206z. It will be noted that the zone-defining portion of each trace 202, 204, 206 includes at least three laterally adjacent traces, as defined earlier in this patent application.

We now discuss zone-defining portion 204z in more detail, but it will be noted that the following description applies to all three zone-defining portions 202, 204, 206. Zone-defining portion is arcuate and 204z comprises six parallel trace portions laterally adjacent to each other. In the embodiment of FIG. 2A, the spacing between the trace portions of zone-defining portion 204z is equal. Within zone-defining portion 204z, it is possible to identify a central region 204c and a boundary region 204d. The central region 204c represents that region of the zone-defining portion 204z which does is not laterally adjacent to either trace portions of traces 202, or 206. The central region 204c is surrounded by the boundary region 204d, which represents the region of the zone-defining portion 204z which is laterally adjacent to trace 206. Alternatively put, the central region 204c is only laterally adjacent to other portions of the same trace 204. In this way, the self-balancing effect is more pronounced in this region 204c.

FIG. 2B shows a heating element 300, very similar to FIG. 2A. The reference numerals having the same final two digits represent the same features as in FIG. 2A (i.e. reference numeral 302 in FIG. 2B represents the same feature as reference numeral 202 in FIG. 2A, and so on), except where stated otherwise. The heating element 300 of FIG. 2B differs from the heating element 200 of FIG. 2A in the geometry of the zone-defining portions 304z and 306z. In heating element 200 of FIG. 2A, each of the zone-defining portions 202z, 204z, 206z were purely arcuate. However, while zone-defining portion 302z of heating element 300 of FIG. 2B is purely arcuate, zone-defining portions 304z and 306z are not. Specifically, a portion 310 which is located at the right-hand edge of zone-defining portion 306z extends radially outwards and into a region which was occupied by zone-defining portion 204z in FIG. 2A. Accordingly, zone-defining portion 306z of heating element 300 of FIG. 2B is substantially arcuate, but has a greater width (in the radial direction) at one end, and zone-defining portion 304z is also substantially arcuate, but has a smaller width (in the radial direction) in a portion 312 at the same end. In the specific example shown in FIG. 2B, the circumferential extent of the wider portion 310 of zone-defining portion 306z is around 10% to 20% of the full circumferential extent of the heating element 300. However, this should not be taken as limiting: the circumferential extent of the wider portion 310 may be no more than 5%, 10%, 15%, 20%, 25%, 30%, 33%, 35%, 40%, 45% of the full circumferential extent of the heating element. The circumferential extent may further be no less than 5%, 10%, 15%, 20%, 25%, 30%, 33%, 35%, 40%, 45% of the full circumferential extent of the heating element. These options may be used to construct a compatible appropriate range of percentages, e.g. 5% to 50%, 10% to 25%, and so on. The same applies to the corresponding circumferential extent of the narrow portion 312 of the zone-defining portion 304z. It should also be noted that it may be any one of the three zone-defining portions 302z, 304z, 306z which include the wider portion 310, and a corresponding second one of zone-defining portions 302z, 304z, 306z which comprise the narrow portion 312. The zone-defining portions may comprise more than one wider portion 310 or more than one narrower portion 312. The wider or narrower portions 310, 312 are preferably located at one or both ends of the zone-defining portions 302z, 304z, 306z. As a result of the presence of the wider/narrower portions 310/312, the boundary between the zone-defining portion 304z and the zone-defining portion 306z is predominantly circumferential, but includes a radial step 314 between two circumferential portions 316, 318.

FIGS. 2C to 2E show heating elements 400, 500, 600 which are broadly similar to the heating element 300 of FIG. 2B. Heating element 400 of FIG. 2C differs from heating element 300 of FIG. 2B in that a region of the zone-defining portion 404z extends radially upwards towards the outer edge of the heating element 400 (except for input portion 402a of trace 402 and input portion 404a of trace 404). As a result, the upper boundary between zone-defining portion 402z and zone-defining portion 404z is mainly circumferential but includes a radial step 420 between two circumferential portions 422, 424. It should still be noted that all parts of the zone-defining portion 404z of the heating element 400 of FIG. 2C include at least three laterally adjacent trace portions. Zone-defining portion 404z includes two main arcuate regions 426 and 428. Arcuate region 426 is substantially elongate, and extends along most of the circumferential extent of the heating element 400. Arcuate region 428 is wider in the radial direction and shorter in the circumferential direction than arcuate 426. It is located at the proximal end 400p of the heating element 400. In heating element 400, all of the resistive traces 402, 404, 406 are of constant width.

The layouts of the traces in heating element 500 of FIG. 2D and heating element 600 of FIG. 2E are identical to the layout in heating element 400 of FIG. 2C. However, in heating element 500 of FIG. 2D and heating element 600 of FIG. 2E, the width of the traces 502, 504, 506, 602, 604, 606 is variable:
FIG. 2D: Here, trace 502 includes a first thicker region 530 which is located at the outer distal region of the zone-defining portion 502z. More specifically, the trace 502 increases gradually from a first width to a second width as one moves longitudinally from the input portion 502a to the zone-defining portion 502z. The trace 502 then gradually reduces in width from the second width to a third width (which may be the same as the first width) as the trace 502 winds throughout the zone-defining portion 502z. The trace 502 then increases in width from the third width to a fourth width (which is greater than the first, second, and third widths) in the output portion 502b. The variation in trace width in trace 504 is less pronounced, but the traces are slightly wider in arcuate region 528 than in arcuate region 526. The input portion 506a of trace 506 is a first width and decreases to a second width in zone-defining portion 506z. In the zone-defining portion 506z, the trace width is slightly narrower at the proximal side than the distal side.
FIG. 2E: The trace widths in heating element 600 of FIG. 2E are subtly different from to heating element 500 of FIG. 2D.

In FIG. 2F, the layout of heating element 700 differs from e.g. heating element 500 of FIG. 2D as follows. In heating element 700, trace 702 (specifically, zone-defining portion 702z thereof) extends further radially inwards, and trace 706 (specifically zone-defining portion 706z thereof) extends further radially outwards to abut zone-defining portion 702z of trace 702. There is no longer a portion of zone-defining portion 704z between zone-defining portion 702z and 706z. In other words, zone-defining portions 702z and 706z are both arcuate, and share a circumferential boundary 732. Zone-defining portion 704z extends, at the proximal end 700p of the heating element 700, across the full radial extent of the heating element 700 (except for the input portion 702a, output portion 702b, input portion 706a, and output portion 706b). Zone-defining portion 704z includes arcuate region 734 which has a greater circumferential extent than an arcuate region 736. The trace width profile of trace 702 is the same as trace 602 in FIG. 2E. The input portion 704a of trace 704 is wider than the zone-defining portion 704z. In arcuate region 734, the trace width is slightly larger at the distal end.

In FIG. 2G, variation in trace width is minimized. Unlike in FIGS. 2A to 2F, in which the spacing between traces is uniform, in FIG. 2G, the trace spacing varies between the different traces 802, 804, 806. In heating element 800 of FIG. 2G, zone-defining portion 804z of trace 804 extends across the full radial extent of the heating element 800 (except for the input portion 802a, output portion 802b, input portion 806a, and output portion 806b). The trace portions in the zone-defining portion 804z are spaced from laterally adjacent trace portions by a first spacing distance. The circumferential extent of the zone-defining portion 804z is narrowest at the outermost and innermost regions (i.e. the regions at which the radial distance from the inner edge of the arc is greatest and least), gradually increasing to a point at which the circumferential extent is greatest approximately halfway across the heating element 800 in a radial direction. Zone-defining portions 802z and 806z occupy substantially the same locations as in FIG. 2F. However, in heating element 800 of FIG. 2G, the outer most trace portion of zone-defining portion 802z does not extend all the way to the distal end 800b of the heating element. Furthermore, the spacing between laterally adjacent trace portions is larger than in FIG. 2F. The boundary 838 between zone-defining portion 802z and zone-defining portion 804z is no longer radial, and is oblique. Zone-defining portion 806z is substantially the same as zone-defining portion 706z in FIG. 7, except the spacing between laterally adjacent trace portions thereof is smaller.

We now present some experimental results. These results were obtained using a computational fluid dynamics model, specifically a conjugate transfer model, which models the solid ceramic in detail based on its material properties, including changes in resistance with temperature. The model also models the geometry of the airflow around the heating element, and takes into account voltage boundary conditions.

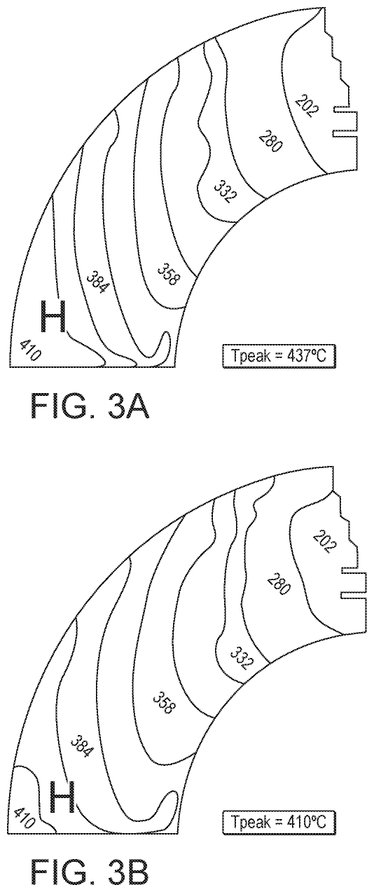

FIGS. 3A and 3B shows a heat distribution in two limiting cases of a prior art heating element as shown in FIG. 1. It may be seen that, in both FIG. 3A and FIG. 3B, there is uneven heating throughout the heating element, with a large peak temperature of 437° C. or 410° C. at the distal end of the heating element (i.e. away from the power input points).

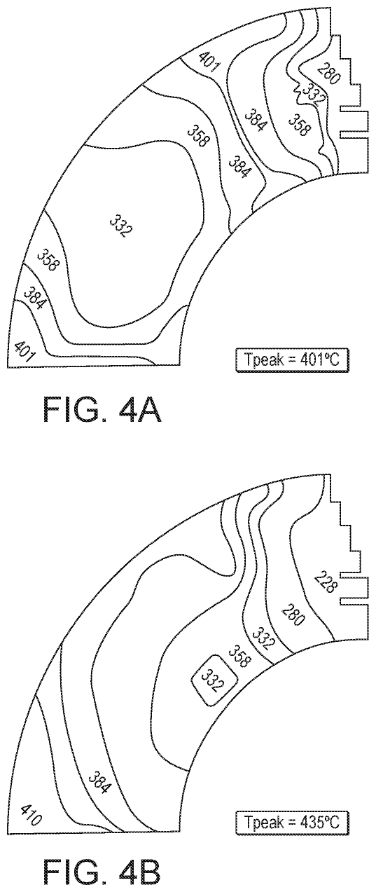

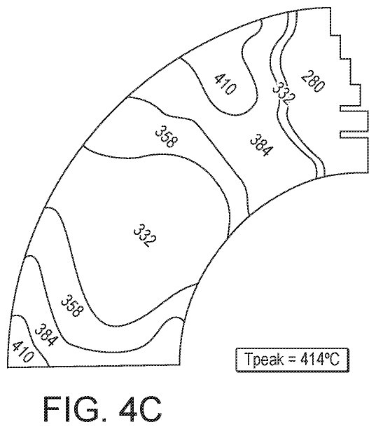

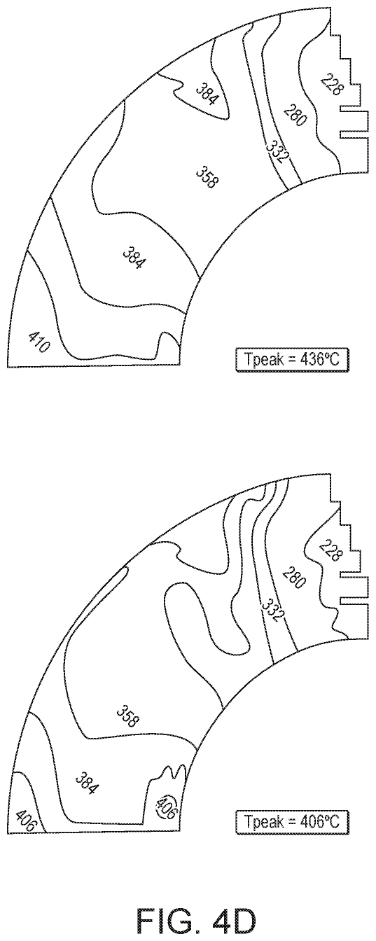

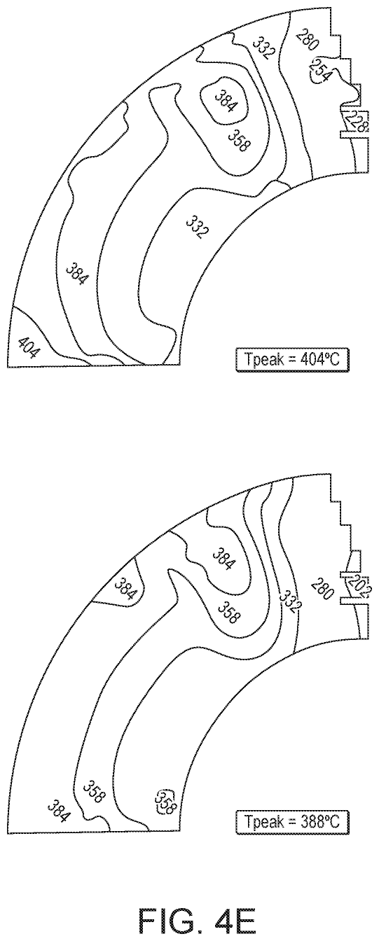

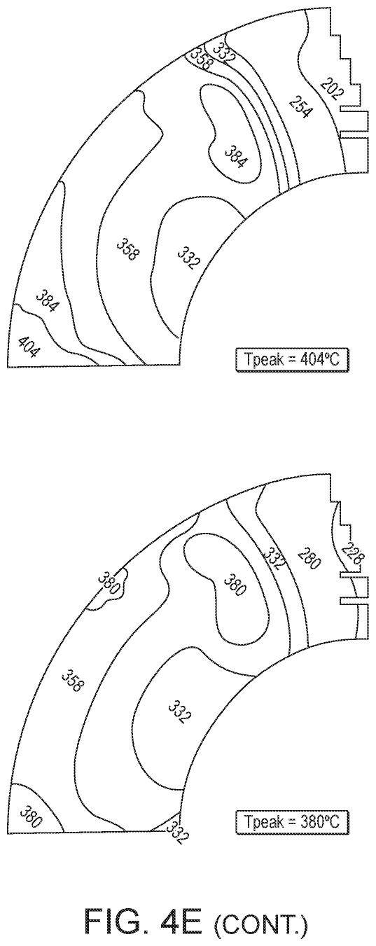

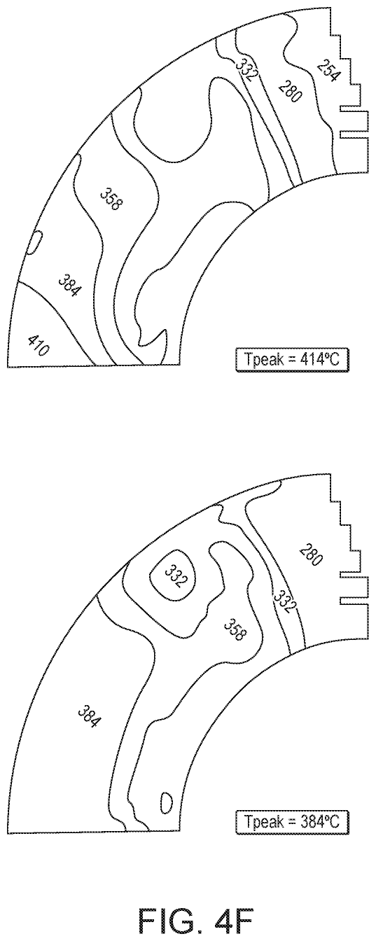

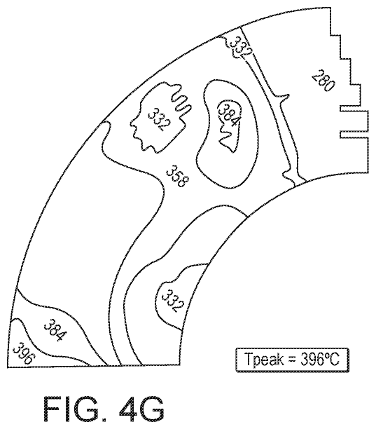

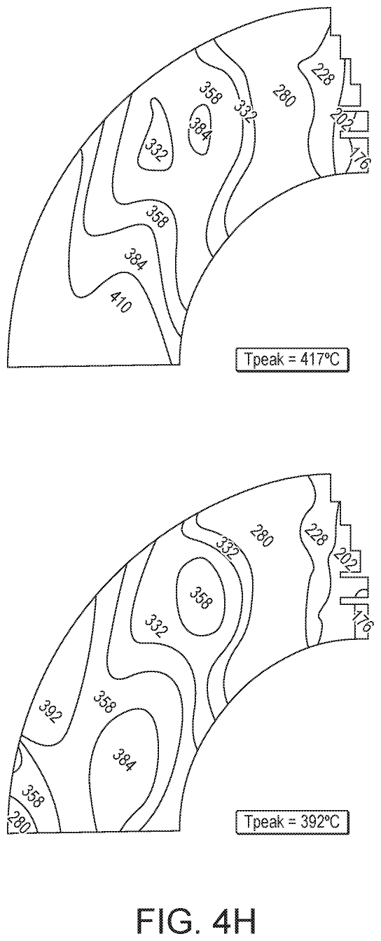

FIG. 4A shows a heat map taken in the first limiting cases (i.e. corresponding to FIG. 3A), obtained from a heating element 200 as shown in FIG. 2A. It may be seen that the runway heating effect at the distal end of the heating element 200 is reduced, and the peak temperature is reduced from 437° C. to 401° C., thereby showcasing the effectiveness of the self-balancing. The overall heating of the heating element 200 is more balanced.

FIG. 4B shows a heat map, again from the first limiting case (i.e. corresponding to FIG. 3A), obtained from a heating element 300 as shown in FIG. 2B. Again, it may be seen that the temperature distribution is more even, with less pronounced heating at the distal end of the heating element 300. There is a reduction in peak temperature from 437° C. to 435° C. This reduction is less pronounced, but given the improved spatial temperature distribution, and the lower peak temperature, this still represents a clear improvement over the prior art case shown in FIG. 3A.

FIG. 4C shows a heat map again from the first limiting case (i.e. corresponding to FIG. 3A), obtained from a heating element 400 as shown in FIG. 2C. Once again, it may be seen that the temperature distribution is more even, with less pronounced heating at the distal end of the heating element 400. There is a reduction in peak temperature from 437° C. to 414° C.

FIG. 4D shows a pair of heat maps, corresponding respectively to the limiting cases shown in FIGS. 3A and 3B, obtained from a heating element 500 as shown in FIG. 2D. It can be seen in both cases, that there is a more even temperature distribution across the heating element 400, with reductions in peak temperature from 437° C. →436° C. and 410° C.→406° C.

FIG. 4E shows four heat maps, the top two corresponding to the limiting case of FIG. 3A, and the bottom two corresponding to the limiting case of FIG. 3B. These heat maps were obtained using heating elements 600 as shown in FIG. 2E. For the first limiting case, it can be seen that the temperature distribution is more even, with (in both cases) a reduction in peak temperature from 437° C.→404° C. The same effect is observed in the bottom two cases, in which there is a peak temperature reduction from 410° C.→388° C. and 410 C. →380° C.

FIG. 4F shows a pair of heat maps, corresponding respectively to the limiting cases shown in FIGS. 3A and 3B, obtained from a heating element 700 as shown in FIG. 2F. It can be seen in both cases, that there is a more even temperature distribution across the heating element 400, with reductions in peak temperature from 437° C.→414° C. and 410° C.→384° C. FIG. 4G shows an additional heat map obtained from the heating element 700 of FIG. 2F in the first limiting case (i.e. corresponding to FIG. 3A) when power balancing was also applied, as described elsewhere in this application. In this case, the temperature distribution is further improved, and the peak temperature further reduced from 414° C.→396° C.

FIG. 4H shows a pair of heat maps, corresponding respectively to the limiting cases shown in FIGS. 3A and 3B, obtained from a heating element 800 as shown in FIG. 2G. It can be seen in both cases, that there is a more even temperature distribution across the heating element 400, with reductions in peak temperature from 437° C.→417° C. and 410° C.→392° C.

It may thus be appreciated that in all examples of heating elements 200, 300, 400, 500, 600, 700, 800 which fall within the scope of the present invention, a more even temperature distribution and reduced peak temperature is observed. In other words, a clear technical effect is achieved across the whole scope of the invention.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A heating element for an appliance, the heating element comprising:
a substrate;
a plurality of resistive heating traces, each trace comprising a first electrical contact and a second electrical contact, each for connection to a power source;
wherein:
each trace comprises:
an input portion connected to the first electrical contact;
an output portion connected to the second electrical contact; and
a zone-defining portion connected at a first end to the input portion and at a second end to the output portion, the zone-defining portion of the trace defining a respective zone and comprising at least three laterally adjacent trace portions of that trace.

2. The heating element of claim 1, wherein:
the zone-defining portion of each trace is arranged in a serpentine fashion; and
the plurality of resistive heating traces are non-overlapping.

3. The heating element of claim 1 wherein:
the substrate is a ceramic substrate; and the plurality of traces are metallic.

4. The heating element of claim 1, wherein:
laterally adjacent trace portions within the zone-defining portion are parallel to each other.

5. The heating element of claim 1, wherein:
the zone-defining portion of each trace of the plurality of resistive heating traces comprises:
a boundary region; and
a central region surrounded by the boundary region, trace portions of the central region laterally adjacent only to the boundary region, the input portion, or the output portion of that trace.

6. The heating element of claim 5, wherein:
in each trace, only the input portion, the output portion and the boundary region of the zone-defining portion are laterally adjacent to a different trace of the plurality of resistive heating traces.

7. The heating element of claim 1, wherein:
the zone-defining portion makes up at least 50% of the length of each trace.

8. The heating element of claim 1, further comprising:
machine-readable indicia defining a respective duty cycle to be applied to each of the plurality of traces by a power supply.

9. The heating element of claim 1, wherein:
the plurality of traces comprises a first trace, a second trace, and a third trace, the zone-defining portion of the first trace defining a first zone, the zone-defining portion of the second trace defining a second zone, and the zone-defining portion of the third trace defining a third zone.

10. The heating element of claim 9, wherein:
the heating element or substrate is arcuate; and
each zone of the plurality of zones is arcuate.

11. The heating element of claim 10, wherein:
a boundary between the first zone and the second zone is circumferential;
a boundary between the first zone and the third zone is radial; and
a boundary between the second zone and the third zone is radial.

12. A heating system for an appliance, the heating system comprising:
the heating element of claim 1;
an electrical power supply configured to apply electrical current to the first contact of each of the plurality of resistive heating traces.

13. The heating system of claim 12, further comprising:
a controller configured to control a respective duty cycle applied to each of the first contacts of the plurality of resistive heating traces.

14. The heating system of claim 13, further comprising:
machine-readable indicia defining a respective duty cycle to be applied to each of the plurality of traces by a power supply
a scanner configured to scan the machine-readable indicia to generate duty cycle data, and to transmit the duty cycle data to the controller,
wherein the controller is configured to control the respective duty cycle applied to each of the first contacts of the plurality of resistive heating traces based on the received duty cycle data.

15. A method of manufacturing the heating element of claim 1, the method comprising:
providing the substrate;
applying the plurality of resistive heating traces to a surface of the substrate;
measuring the operational power draw of each of the plurality of resistive heating traces;
calculating a respective duty cycle to be applied to each of the plurality resistive heating traces; and
encoding the calculated duty cycles in machine-readable indicia and applying the machine-readable indicia to the heating element.
